(19) United States
(12) Patent Application Publication
(10) Pub. No.: US 2007/0255627 A1
(43) Pub. Date: Nov. 1, 2007

(54) Transport Ordering Systems and Methods

(76) Inventors: Zachary Emerson Hallowell, San Francisco, CA (US); Susan Benson Thomas, Mesa, AZ (US); Clarence Joseph Hammond, Fremont, CA (US)

Correspondence Address: WILSON SONSINI GOODRICH & ROSATI, 650 PAGE MILL ROAD, PALO ALTO, CA, 94304-1050, US

(21) Appl. No.: 11/681,727

(22) Filed: Mar. 2, 2007

Related U.S. Application Data
(60) Provisional application No. 60/743,406, filed on Mar. 3, 2006.

(51) Int. Cl. G06Q 30/00

(52) U.S. Cl. 705/26

(57) ABSTRACT

An embodiment is directed to a computerized method in vehicle transport. A request regarding transport of a vehicle is received over a computer network. Electronic information regarding a pick-up location and electronic information regarding a drop-off location for transport of the vehicle are accessed, and based on the electronic information regarding a pick-up location and information regarding a drop-off location for transport of the vehicle quotation of cost for transfer of the vehicle is automatically generated. A quotation for cost for transport of the vehicle is transmitted electronically to the user, over a computer network. A request to transport the vehicle is received, and based on a request to transport the vehicle, an electronic request to a transporter to transport the vehicle is automatically initiated. Also described is an internet-based system, an automated system in vehicles sales, as well as other methods and systems.

### CROSS-REFERENCE

This application claims the benefit of U.S. Provisional Application No. 60/743,406, filed Mar. 3, 2006, which application is incorporated herein by reference.

### BACKGROUND OF THE INVENTION

Vehicle dealers and others are often involved in arranging transport of a vehicle. For example, after selling a vehicle, a vehicle dealer may desire to transport the vehicle to a destination. The process of arranging the transport may be cumbersome and time consuming. Accordingly, there is a need for improved methods and systems for arranging transport of vehicles.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1 shows an initial page of a user interface related to transport, according to an embodiment of the invention.

FIG. 2 is a flow diagram of transport ordering, according to an embodiment of the invention.

FIG. 3 shows a user interface for ordering transport, according to an embodiment of the invention.

FIG. 4 shows a user interface for payment, according to an embodiment of the invention.

FIG. 5 shows a user interface for the user to confirm an order for transport, according to an embodiment of the invention.

FIG. 6 shows a user interface to confirm to the user an order for transport, according to an embodiment of the invention.

FIG. 100 is a block diagram of a system with a bidding tool, according to an embodiment of the invention.

FIG. 200 is a more detailed block diagram of a system with a bidding tool, according to an embodiment of the invention.

### DETAILED DESCRIPTION OF THE INVENTION

While preferred embodiments of the present invention have been shown and described herein, embodiments are provided by way of example only. Numerous variations, changes, and substitutions will now occur to those skilled in the art without departing from the invention. It should be understood that various alternatives to the embodiments of the invention described herein may be employed in practicing the invention.

An embodiment of the invention is directed to an electronic system that allows a user to order and/or pay for the transport of an automobile via an automatically generated, guaranteed price. The transportation may be arranged separate from the online purchase of a vehicle or as part of the online purchase process.

According to various embodiments, the invention may include or be used in:
A host computer network, which serves the web site(s) on which the item is available for viewing and purchase.
A host database, which contains a detailed description of the item, its configuration and condition.
A set of user modules, described below, which provide for varying levels of permissions to access to the item data.

Various embodiments of the invention may include, for example, modules such as an administration module and a buyer module. An administration module may include, according to an embodiment, the following or subsets thereof:
An interface for creating cost matrices, including:
   Location to location (e.g., state-to-state or zip code to zip code) factors for adjusting the cost of transportation.
   Per mile transport costs or cost per mileage range (e.g., 50 to 100 miles=$95)
   Accepted payment methods.
A module that calculates the distance between locations (e.g., straight line or road miles).

A buyer model may include, according to an embodiment, the following or subsets thereof:
An interface for accessing the system (username, password).
A control for receiving a quick transport quote, based on zip codes.
A workflow for ordering the transport of a vehicle or purchase of a vehicle concurrently with transport.
A report for viewing the status of transportation.

An embodiment of the invention may include logic and an interface or interfaces for users. The users are vehicle dealers, or other buyers, according to various embodiments. Thus, references to the user apply to the dealer, according to various embodiments. An automated transport quoting and ordering (transport ordering) component may be available to the user through a page or panel on a web site. Note that the various interfaces and displays may be provided in the form of interfaces on the user's computer, which may be provided in the form of web pages served by a web server, other user interface windows, or other forms of electronic display to the user. Embodiments of the invention include logic and a system or systems providing the functionality and interfaces described herein. For example, the modules described herein may be implemented as software modules, according to an embodiment of the invention.

If the transport ordering component is associated with the site, according to an embodiment, when the user logs in this component is presented to the user in the user's navigation. An embodiment of this component may have logic and interfaces providing:
1. Prompting a user request and displaying a quick quote.
2. Prompting a user request arranging transport, and providing associated results, including the following or subsets thereof:
   a. Step One
      i. Upload vehicle identification number (VIN) and basic vehicle information.
      ii. Upload contact information.
      iii. Upload pick-up and drop-off information.
      iv. Add special transport instructions.
   b. Step Two
      i. Receive transport quote (estimated number of days, estimated arrival date, and cost).
      ii. Select payment options.
         (1) Credit card
         (2) Dealer check
         (3) ACH (Automated Clearing House Network)
   c. Step Three
      i. Confirm order.
      ii. Add general comments.
   d. Step Four
      i. Receive transport order confirmation.
3. Allowing a user to view transport status, for example, in the form of a report.
4. Handling and/or display of terms and conditions.
5. Editing location information.

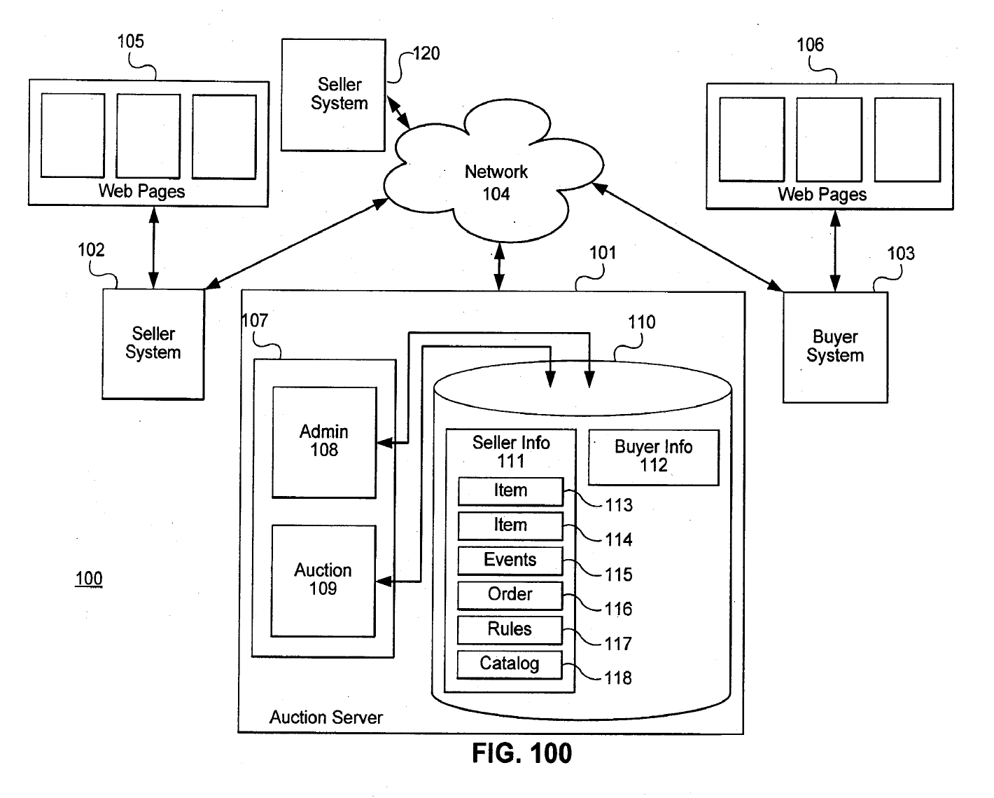

FIG. 1 shows an initial page of a user interface related to transport, according to an embodiment of the invention. According to an embodiment, when the user clicks on a transport link, the system will take the user to (and thereby display) a main transport page. The landing page gives the user access to the arrange transport, quick quote and the transport status functions.

The exemplary interface of the loading shown includes introductory text 11, a VIN entry 12, a submit button 13, a transport status entry 14, and a quick quote section 17.

Entering VIN input 12 accepts a VIN, and upon clicking submit 13, the user is sent to a more detailed portion of the system to proceed with submitting and processing an order for transport. Transport status 14 allows the user to generate and receive a status report 15 or search for a status for a particular vehicle by entering the VIN entry 16. The quick quote section 17 may include entries for abbreviated information regarding start (pick-up) and destination (drop-off) locations, which are shown in this example as entries for pick-ups at zip code 18 and drop-off zip code 19. The interface also provides abbreviated information regarding the vehicles such as a selection between different sizes of the vehicle, entries 20 for small, medium, or large, and entries for operable or inoperable 21. After selecting an appropriate button on the quick quote section, estimate 22 is provided.

Thus, the system may include an interface or display in an interface that prompts a user to request a quick quote. The quick quote functionality may help a dealer to get a quote for a transport without having to enter all of the vehicle, pick-up, and drop-off information.

The dealer will see the estimated quote and can then determine whether he would like to have the service provider transport the vehicle or not. Some embodiments for such a quick quote method and system are shown below. Various embodiments may include some or all of the functionality described in these cases, in various combinations.

Quick quote use case #1:
1. User logs into a vehicle sale or auction system and selects a prompt for transport from the navigation.
2. System takes the user to the transport landing page.
3. User enters the zip code for the pick-up location and the zip code from the drop-off location.
4. User selects the size of the vehicle: small, medium, or large. According to an embodiment, this or other information is derived from the VIN via a decoding of the vehicle type mapped to a vehicle size.
5. User selects whether the vehicle is operable or not.
6. System generates a quote based on the information provided by the user. The quote includes the estimated number of days and the cost of the transport.
   a. The quote estimate may be based on various factors, for example distance between pick-up and drop-off locations and the respective category. Distance may be the distance between respective zip codes. Distance may include road miles distance, for example between respective zip codes. The system may use other cost matrices, for example straight-line distance between pick-up and drop-off locations (e.g., between zip codes). Such other matrices may be used, for example, if a road-mile calculation is unavailable.
   b. The quote estimate may be based on vehicle size, and thus an embodiment of the system prompts the user for such information.
   c. The quote estimate may be based on whether the vehicle is operable or inoperable, and thus an embodiment of the system prompts the user for such information.
7. The user sees generated quote (this includes cost and timing estimated—timing may include days for travel or date of arrival).

Quick quote use case exception #1: The system may also store a set of zip codes for which transportation quotes will not be provided. Should one of those zip codes be entered, a message indicating this fact would be posted to the dealer. Thus, an embodiment may include the following:
1. The user enters a zip code that the service provider does not transport to or from.
2. The system provides a message stating that this is a zip code that we do not transport to or from.

An order transport section may include a workflow the user goes through in order to complete the transport ordering process. According to an embodiment, the user is not allowed to move to the next step without completing all of the required information from the previous step. An embodiment of this component may have logic and interfaces providing the items below. According to an embodiment, each step is consistent with one page of the system. Vehicle information is provided by the user or is accessed from storage. Information that is missing is provided regarding the vehicle, as well as contact information, location information, and special transport information. A quote is generated and provided to the user, and payment information is prompted for and received. The order is confirmed by the user and a confirmation message is provided to the user. Thus, an embodiment allows for automatic generation of transport quotation and ordering.
1. Step One
   a. Upload VIN and describe the vehicle (i.e. Year, Make, Model).
2. Step Two
   a. Add any vehicle information that is missing.
   b. Add contact information for the pick-up and drop-off locations (optional).
   c. Add pick-up and drop-off location information.
   d. Add special transport instructions.
3. Step Three
   a. Receive Transport Quote Cost (estimated system calculated cost and estimated number of days and cost).
   b. Select Payment Options.
      i. Credit Card.
      ii. Dealer Check.
      iii. ACH (Automated Clearing House Network).
4. Step Four
   a. Confirm Order.
   b. Add General Comments.
5. Step Five
   a. Receive Transport Order Confirmation on screen and/or via e-mail notification.

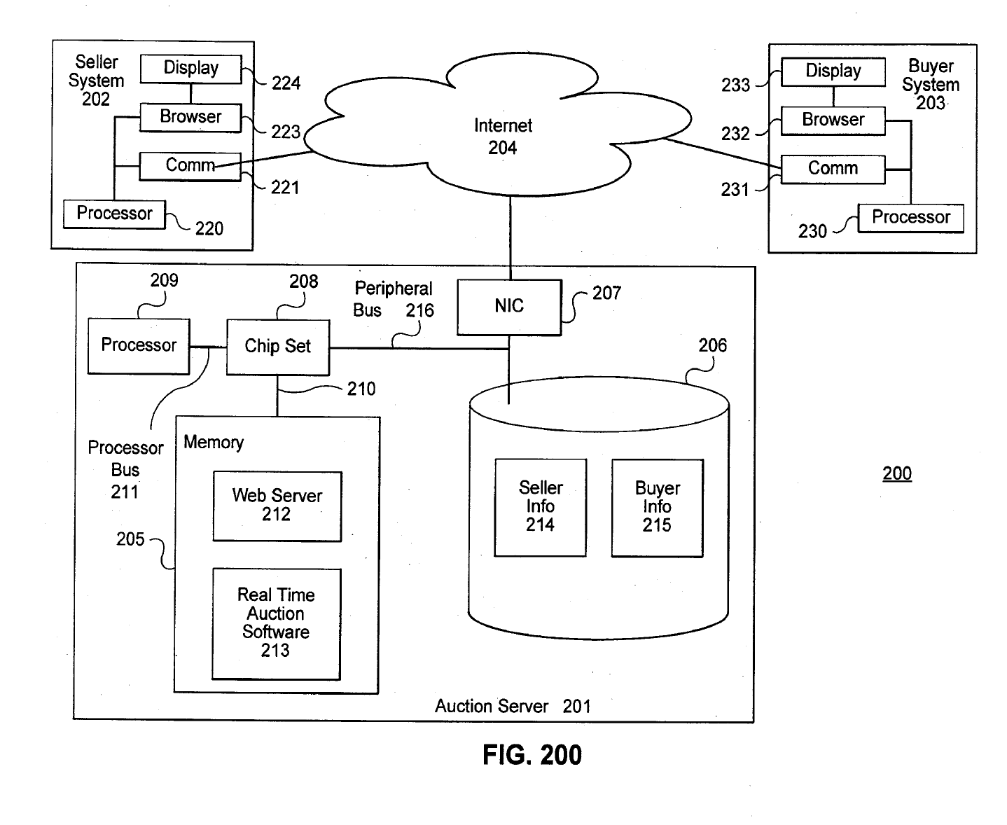

FIG. 2 is a flow diagram of transport ordering, according to an embodiment of the invention. Embodiments of the system and process shown allow for automated quotation orders for transport of vehicles and the processing and initiating of such transport orders. The method may be implemented in various forms including a software method, and may be embodied in a system for processing information related to vehicles, such as in an on-line vehicle sale system or vehicle auction system.

The process may start with a request for a transport order, and include prompting the user for various items of information about the vehicle and desired transport. The information may include, for example start (e.g., pick-up) and destination (e.g., drop-off) locations. Information about the vehicle may include items such as vehicle type and condition. User information may also be collected and used. Some of the information used may be provided and stored before the user requests transport and thus is available to the process and/or system before prompting the user. The information that is obtained earlier may be used, for example, to pre-populate user prompts on the user interface that the user can accept or update as needed. The process includes calculating and displaying information to the user regarding the requested transport, such as the cost, and estimated timing. The user can then select payment option and confirm the order.

As shown in FIG. 2, the process may start with a user (dealer) entering a VIN (block 21). It is determined whether the VIN is in the system (block 22), and if the VIN is in the system, it is determined whether the vehicle was purchased through the service provider's system (block 23). If the vehicle was purchased through the service provider's system, it is determined whether the vehicle has been paid for (block 24). If the vehicle was not paid for, according to an embodiment, the dealer is not allowed to arrange transport until the vehicle has been paid for (block 25). If the vehicle has been paid for, the system lists the vehicle information already stored on the vehicle and proceeds to allowing the dealer to enter additional vehicle information (whether the vehicle is inoperable, etc.) (block 28). If the VIN is not in the system (block 22), then the system will decode the VIN (block 26). After decoding the VIN, the system then also proceeds to having the dealer enter additional vehicle information (inoperable, etc.) (block 28).

After having the dealer enter additional information (inoperable, etc.) (block 28), the service provider's system prepopulates contact information based on the user's information (block 29). It is determined whether the dealer elects to modify the stored contact information (block 30), and if so, the system proceeds to providing a user interface for the user to select preferences to update and then return back (block 31). After the preferences update or, if the dealer does not need to update contact information, it is determined whether the dealer has contact information already stored (block 33). If the dealer does not have pick-up and drop-off information stored, the user is provided an interface for entering pick-up and drop-off information and such information is obtained by the system (block 34). Next, the dealer can add special transport instructions (block 35). If the dealer does have pick-up and drop-off information stored (block 33), the system provides an interface pre-populated with pick-up and drop-off information (block 32). Next, the dealer can add special transport instructions (block 35).

After receiving special transport instructions or user selection to continue, the system provides a final transport price and allows the dealer to add transport notes (block 36). The dealer then selects payment option (block 37) and adds transport (block 38). The system then displays a confirmation screen and allows the dealer to modify incorrect information (block 39), and a transport order confirmation e-mail is sent to the dealer (block 40).

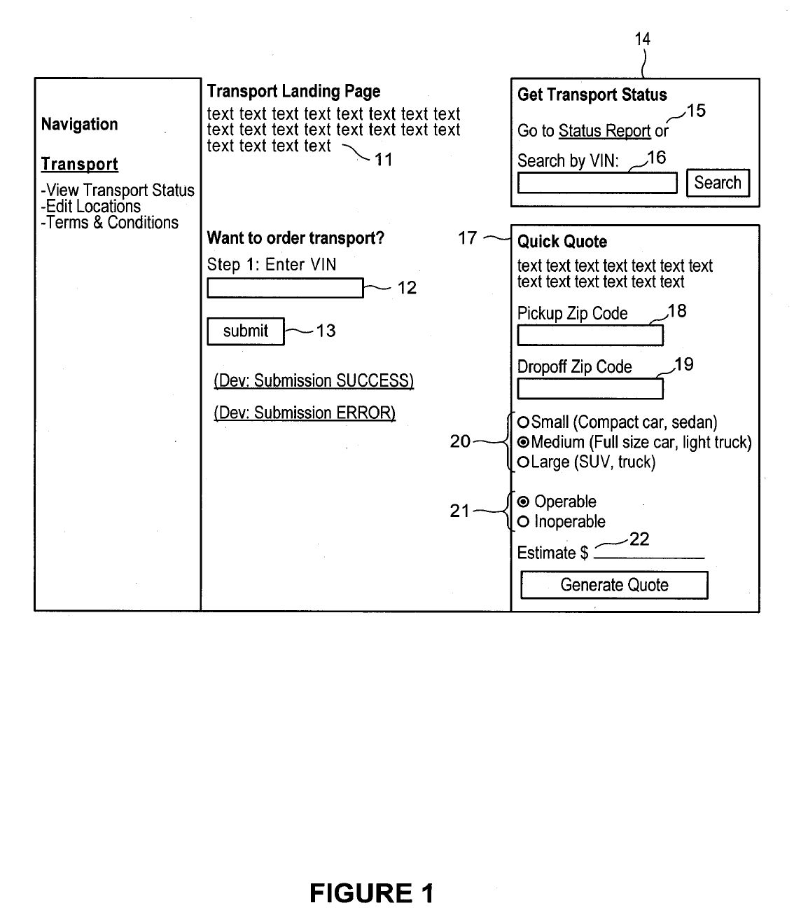

FIG. 3 shows a user interface for ordering transport, according to an embodiment of the invention. The interface for ordering transport includes request for various items about the vehicle, the user, and the start and destination locations of the transport. This information may include basic vehicle information. According to various embodiments the information includes, in whole or in part or in various combinations: VIN; year, make, model and series; color; mileage; whether the vehicle is operable or inoperable.

According to an embodiment, the interface may include entry fields where the user can enter vehicle information 45, contact information 46, and location information 47. Vehicle information 45 may include items such as vehicle identification number (VIN), style, year, make, model, series, color, mileage, and whether the vehicle is inoperable. According to an embodiment, the VIN may be already provided in a previous step, and the various items in the interface may be available as for free text entry or as pull down menus. For example, style may be selected from a pull down menu as shown. Other items, such as the year and make may be free text entry. Additionally, some of these items may be pre-populated with information available from the VIN. Certain items may be available as a check box, for example, the operable/inoperable indication. Contact information 46 includes entries for the user to enter information regarding the user's contact information, such as the user's name, telephone number, alternate telephone number, and e-mail address. The interface may optionally allow the user to update and save the new contact information, for example through a link to a preferences screen.

Location information 47 provides an opportunity for the user to enter information about start and destination locations. The locations may provide free form entry for certain information about the locations, such as a name, address, city, state, zip code, contact person name, contact person telephone, alternate telephone, and e-mail address. Similarly, such information may be provided for the drop-off location. Additionally, the interface may provide an option for the user to select pick-up and/or drop-off locations from among previously stored locations. These may be available, for example, through a drop down menu as shown. These previous locations may be particular stored locations; alternatively, previous locations may be available as previously used locations even though the user may not have specifically selected to save such locations. Additional entry, such as free text entry 50 may be provided to allow the user to allow special transport instructions. The interface may include various other buttons, such as back and continue buttons shown here at the bottom of the interface.

Various embodiments may include some or all of the functionality described in these cases, in various combinations.

Arrange transport use case #1:
1. User logs into the web site and clicks on the transport link in the left navigation.
2. User enters the VIN.
3. The system determines the following based on the VIN:
   a. Is the vehicle already in the system and what is the status?
      i. If any status other than sold, then the system will display the VIN, year, make, model, series, color and mileage that is stored. System will allow user to update all fields except for VIN, year, and make.
      ii. Optional verification of purchase: If the status is sold (in one embodiment meaning the vehicle was purchased within the particular system), then has it been paid for?
         1. If yes, then the system will take user to page Step Two.
         (a) System will display the VIN, year, make, model, series, color, and mileage that is stored. System will allow user to update all fields except for VIN, year, and make.
         (b) System will default vehicle to ‘operable’ but will allow the user to change.
         2. If no and verification of vehicle purchase is turned on for the transport module, then the system will return an error message that indicates that the vehicle was purchased off of one of the system powered sites and has not been paid for and that the vehicle must be paid for before transport can be arranged through the system.
   b. If the vehicle was not found in the system, then the system will decode the VIN and display the following:
      i. Year (possibly derived from the VIN).
      ii. Make (possibly derived from the VIN).
      iii. Model/series (possibly derived from the VIN). The user will be allowed to change.
      iv. User will be prompted to enter mileage.
      v. User will be prompted to enter color.
      vi. System will default vehicle to operable but will allow the user to change the flag to inoperable.

Use case #2 exception (Precondition: System decodes VIN):
1. System decodes the VIN and returns the dropdown box of styles (year, make, model combination derived from the VIN) the user must select.
2. User selects the style.
3. User does not enter all required additional vehicle information: mileage or color.
4. User enters the required information under the rest of the sections of the page (contact information and pick-up and drop-off locations).
5. User clicks the continue button at the bottom of the page.
6. System returns an error message indicating that the user has not completed all of the required information. The message may indicate certain items highlighted in red are required (for example, items highlighted in red).

The system obtains and uses information about the user. In various embodiments, the user comprises a dealer. The system may populate the contact information with information about the user, such as contact name, phone, and e-mail address, as used for ordering and effecting transport. If the user does not have one of the requested pieces of information, then it may be requested and/or provided, for example through a preferences page. According to an embodiment, if a preferences page is used, the user may be given a link to the preferences page that allows the user to update the user information and then return to this page. Information about the user includes, according to various embodiments, in various combinations or subcombinations: contact name, telephone number, e-mail address, and/or emergency telephone number.

Various embodiments may include some or all of the functionality described in these cases, in various combinations.

User (dealer) contact information use case #1 (Pre-conditions: User has entered vehicle information; user has no phone number saved; user has no e-mail address saved; user has no emergency phone saved):
1. System will automatically populate the contact information with the user's information.
2. System will provide a link to a preferences page.
3. User does not go to the preferences to update the contact information.
4. User completes the other sections of the page (vehicle information, and pick-up and drop-off information) and then clicks a continue button.
5. System generates an error message that indicates that the user has not completed all of the required information. Items highlighted are requested.
6. User clicks on the link to the preferences tab.
7. User updates user's phone number and e-mail address and clicks save.
8. System provides user with a button to return to a transport page.
9. Dealer/User clicks on the button to return to a transport page.
10. System returns user to page step two.
11. System displays the contact name, phone and e-mail address.
12. User completes the other sections of the page and then clicks a continue button.
13. System does not generate an error message.

User (dealer) contact information use case #2 (Preconditions: User has entered the vehicle information):
1. System prepopulates the following fields with the user's saved contact information.
   a. Contact name (e.g., first and last names).
   b. Telephone.
   c. E-mail address.
   d. Emergency telephone number (filled in if it was entered).
2. User does not edit the information provided.

User (dealer) contact information use case #3. (Preconditions: User does not have all contact information that the system will use.)

The user is prompted to enter pick-up and drop-off locations. Frequently the same location may be used in many of a user's transports. In order to save the user time in entering location information for a location that they will use multiple times, the user will be able to save the user's locations. According to various embodiments, the user can save many locations. In addition to the user's saved location, the system will remember up to some number of recent locations (such as 10) that the user did not select. Thus, an embodiment provides saved locations and recent locations and the user will be allowed to use these locations for either pick-up or drop-off by selecting them from the user interface, such as from a dropdown box. The drop down box will list the saved locations at the top and the most recent at the bottom. The information stored for each location may include, in various combinations and subcombinations: location name, address, city, state, zip, contact name, telephone number, alternate telephone number, and e-mail address.

Various embodiments may include some or all of the functionality described in these cases, in various combinations.

Pick-up and drop-off use case #1 (Preconditions: User has the entered vehicle information; user has entered contact information; this is the first time the user is using the transport only feature; the user does not have any saved locations and does not have any recent locations):
1. User enters the following pick-up location information:
   a. Location name.
   b. Address, city.
   c. State will be a dropdown box of all states.
   d. Zip code will only allow user to enter up to 5 numbers.
   e. Contact name.
   f. Contact telephone number (for example, allows user to enter an alternate number in fields for 3, 3, and 4 digits).
   g. Alternate telephone number (for example, allows user to enter an alternate number in fields for 3, 3, and 4 digits).
   h. E-mail.
   i. User selects a checkbox to add to user's locations.
2. System will save this location to the user's saved locations. These locations are saved per user.
3. User enters drop-off location information:
   a. Location name (required).
   b. Address, city.
   c. State will be a dropdown box of all states.
   d. Zip code will only allow user to enter up to 5 numbers.
   e. Contact name.
   f. Contact telephone number (for example, allows user to enter phone number fields for 3, 3, and then 4 digits).
   g. Alternate telephone number (for example, allows user to enter an alternate number in fields for 3, 3, and 4 digits).
   h. E-mail.
4. User does not select to save to user's location.
5. System will save this location as a recently used location.

An embodiment of the system allows the user to add instructions about the transport. For instance, if one of the locations is closed at a particular time (such as the weekend), then the system passes that information to the transporter, for example as provided by the user, so that the transporter knows not to pick-up the vehicle at that particular time (such as the weekend). Various embodiments may include some or all of the functionality described in this case, in various combinations.

Special transport instructions use case #1:
1. User enters special transport instructions.
2. System saves these instructions.
3. System displays these instructions on the dealer confirm and receipt pages.

After the user has entered all of the required information for step two and clicked on the continue button, the system will generate a transport quote (cost and estimated days). The system will display the payment methods available for transport. Various payment methods may be provided. For example, payments may be provided in various combinations and subcombinations of dealer check, automated bank account debit and credit card.

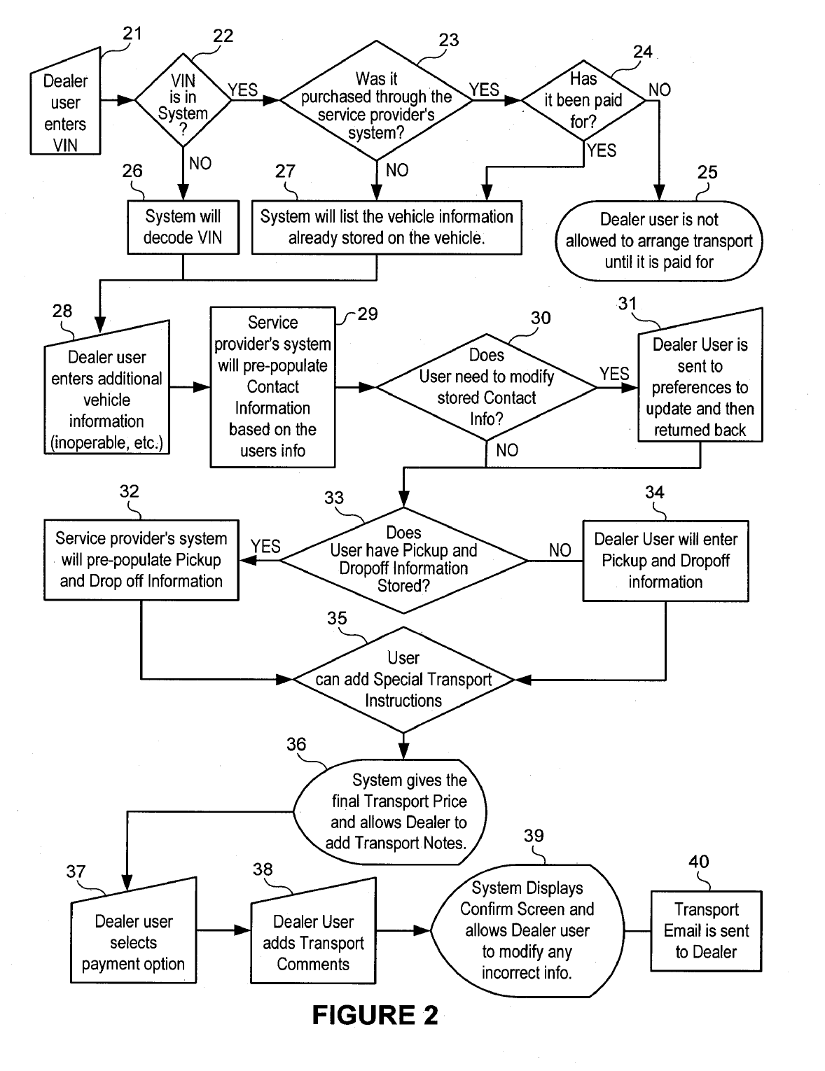

FIG. 4 shows a user interface for payment, according to an embodiment of the invention. The interface for payment includes a transport summary 55, payment information section 56 including contact information 58, payment method 57, and a total cost 59. Transport summary is information provided in the previous step, according to an embodiment. The interface may provide an option for the user to edit this information. Contact information may be provided in the previous step, but the user may be provided an option to edit this information. The summary may also include pick-up and drop-off locations provided in previous steps. Payment information 56 includes a transport quote, which may include an estimated number of days, and an estimated delivery date. Payment information 56 includes a selection under which the user can select different types of payment. According to one embodiment, multiple types of payment are available, for example, three types, as shown here, dealer check, ACH, and/or credit card. Contact information entry 58 is also provided where the user can enter respective contact information. This contact information 58 may include first name, middle name, last name, address, city, state, zip code, credit card type, credit card number, expiration date, security code, and/or an optional entry to save the credit card information. The total cost 59 is provided, which may include the cost of the quote, plus other additional charges, such as charges depending on the form of payment used.

Users, such as dealerships, are allowed to pay for their transport by check according to an embodiment. Various embodiments may include some or all of the functionality described in this case, in various combinations.

Check payment use case #1 (Preconditions: User has all three payment methods granted; user has entered information on page step two and returned no errors; system has generated a quote and estimated number of days):
1. User clicks on check as the payment method.
2. User clicks continue button at the bottom of page step three.
3. System generates the confirm page.
4. System displays the settlement information that includes check payment instructions.

Users, such as dealerships, are allowed to pay for their transport by ACH payment method. The system will receive ACH account information submitted by or for the respective users. If the user is not set up, then the system provides a link next to the ACH payment method that gives the user information on ACH with instructions for setup.

Various embodiments may include some or all of the functionality described in this case, in various combinations.

ACH payment use case #1 (Precondition: User does not have an ACH payment method):
1. System shows the list of payment methods.
2. System displays link next to the ACH payment method.
3. User clicks on link.
4. User sees a static page of instructions on how to get registered with the ACH payment method.

ACH payment use case #2. (Preconditions: User has all three payment methods granted;

user has entered information on page Step Two and returned no errors; system has generated a quote and estimated number of days.)
1. User clicks on ACH as the payment method.
2. User clicks on continue button at the bottom of page Step Three.
3. System verifies the user's (e.g., dealer's) credit line amount, and, if user has enough credit, then user can use this payment method.
4. System display generates the confirm page.
5. System displays the settlement information that includes automated bank account debit payment instructions.

ACH payment use case #2a: Exception:
1. User clicks on ACH as the payment method.
2. User clicks on continue button at the bottom of page Step Three.
3. System verifies that the user (e.g., dealer) does not have enough credit.
4. System returns user to page Step Three with the error message stating that user does not have enough line of credit at this time. Prompt user to select another payment option. Prompt user to call at a specified telephone number if user would like to speak with one of the reps about user's available credit.

Users, such as dealerships, are allowed to pay for their transport by using credit cards. Users will also be allowed to save one or more credit cards. The credit card will be stored and the system will allow the user to use it again without having to re-enter it. According to an embodiment, the number is saved and encrypted so that no user has access to see the full credit card number through either the interface or in the database.

Credit card payment use case #1 (Preconditions: User has all three payment methods granted; user has entered information on page Step Two and returned no errors; system has generated a quote and estimated number of days; user has no credit card information presaved):
1. User clicks on credit card as the payment method.
2. User clicks on continue button at the bottom of page Step Three.
3. The system now makes the credit card fields available to the user to edit.
4. The user enters all of the required credit card fields which are:
   a. Name (e.g., first name, middle name and last name).
   b. Address, city, state, zip.
   c. Credit card type, e.g., VISA, MasterCard, Discover, and American Express.
   d. Credit card number.
   e. Expiration date.
   f. Security code.
5. User clicks button to save credit card information.
6. User clicks a continue button.
7. System saves the credit card information for this user.
8. System sends credit card transaction to authorization service (e.g., authorize.net.).
9. System receives approved message from authorization service (e.g., authorize.net.).
10. System takes user to page Step Four.
11. System displays settlement information for credit card.

Credit card payment use case #2:
1. User clicks on credit card as the payment method.
2. The system now makes the credit card fields available to the user to edit.
3. The user does not enter all required credit card information.
4. User selects save credit card information.
5. User clicks the continue button on the bottom of page Step Three.
6. System returns user to page Step Three with the error message that the user has not completed all of the required information. The system requests missing items which may be highlighted. Different embodiments may have different sets of information that are used.
7. System does not save the credit card information until it is complete.

Credit card payment use case #3:
1. User clicks on credit card as the payment method.
2. User clicks on continue button at the bottom of page Step Three.
3. The system now makes the credit card fields available to the user to edit.
4. The user enters credit card information for which user is prompted.
5. User clicks the continue button.
6. System sends credit card transaction to authorization service.
7. System receives error message from authorization service.
   a. The error message will state what was wrong. Examples:
      i. Address does not match.
      ii. Name is not correct.
      iii. Expiration date is not correct.
      iv. Etc.
8. System returns user to page Step Three with the appropriate message telling the user exactly what was wrong. (Please see authorization service (e.g., authorize.net) document for a full list of error codes from authorization service and the exact error message that should be displayed for each).

Credit card payment use case #4:
1. User clicks on ‘Credit Card’ as the payment method.
2. The system now makes the Credit card fields available to the user to edit.
3. The user enters Credit Card information for which user is prompted.
4. User clicks ‘Save Credit Card Information.’
5. User clicks the ‘Continue’ button.
6. System saves credit card information per user.
7. System sends credit card transaction to authorize.net.
8. System receives ‘Decline’ message from authorize.net.
9. System returns user to page Step Three with the error message ‘Unfortunately your card has been declined. Please contact your credit card company for more details. Please enter another credit card.’
10. The credit card fields are not filled out so that the user can fill in new card information.

Credit card payment use case #5 (Preconditions: Dealer has saved previous credit card information):
1. User clicks on credit card as the payment method.
2. System populates all credit card fields with the saved information.
   a. The credit card number is displayed as xxxx-xxxx-xxxx-xxxx with the last four numbers shown, matching the last four of the users credit card.
3. User clicks continue.
4. System sends credit card transaction to authorization service (e.g., authorize.net).
5. System receives approved message from authorization service (e.g., authorize.net).
6. System takes user to page Step Four.
7. System displays settlement information for credit card.

Credit card use case #6 (Preconditions: User has saved previous credit card information):
1. User Clicks on credit card as the payment method.
2. System populates all credit card fields with the saved information.
   a. The credit card number is displayed as xxxx-xxxx-xxxx-xxxx with the last four numbers shown, matching the last four of the users credit card.
3. System provides an edit link for the credit card information.
4. User clicks update and edits the credit card fields.
5. User selects save credit card information button.
6. User clicks continue.
7. System saves the new credit card information.
8. System sends credit card transaction to authorization service (e.g., authorize.net)
9. System receives approved message from authorization service (e.g., authorize.net).
10. System takes user to page Step Four.
11. System displays settlement information for credit card.

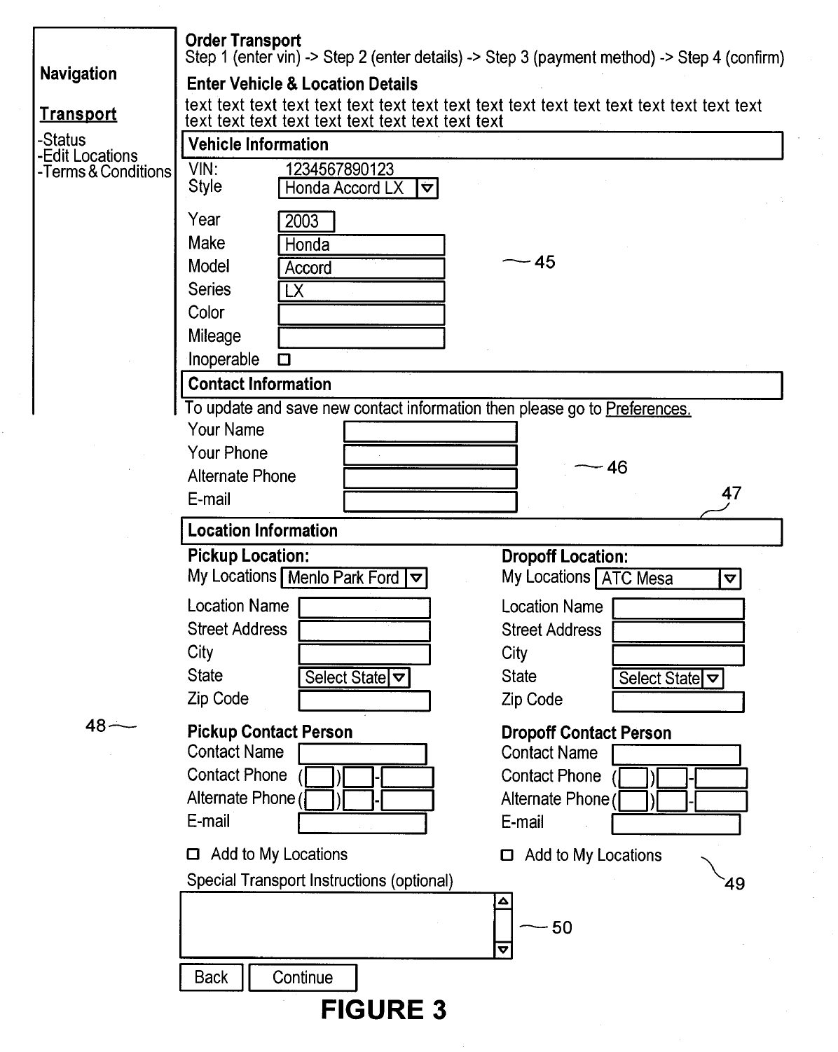

FIG. 5 shows a user interface for the user to confirm an order for transport, according to an embodiment of the invention. The user interface may come after the transport Step Four. It is a page or interface that provides the transport information and a link to the user's transport order confirmation. The interface may include a transport summary 62, contact information summary, payment information summary 63, general comments field 64, terms and conditions 65 and a box to indicate the user has read and agreed to the terms and conditions 66. The transport summary shown at 62 may include information such as the VIN, year, make, model, whether the vehicle is operable, pick-up location, and drop-off location. Contact information may include name, telephone number, alternate telephone number, and/or e-mail address. Each of the transport summary and contact entries information may be editable according to an embodiment of the invention. Payment information 63 summarizes transport cost, payment method and associated cost, and total cost. General comment entry 64 provides the user an opportunity to add additional comments. Terms and conditions 65 summarizes terms and conditions that are applicable. These conditions may be applicable to the order, and may be designed to bind the user to agree to the terms of the transport. An additional item in the user interface, such as the check box or other button or key is provided to allow the user to indicate that the user has agreed to the terms and conditions, such as check box 66 as shown here.

The user interface for the user to confirm an order for transport as shown in FIG. 5 may be provided as a web page or other user interface item. It includes the following pieces of information in various combinations and subcombinations according to various embodiments of the invention:
1. VIN.
2. Year, make, model, series.
3. Pick-up location name.
4. Drop-off location name.
5. Estimated days to deliver.
6. Payment method.
7. Transport cost.
8. Settle with the system operator.
   a. Payment type.
   b. Description.
   c. Payment due (number of days).
9. Provide links to the transport order confirmation of sale, transport ordering page or landing page.

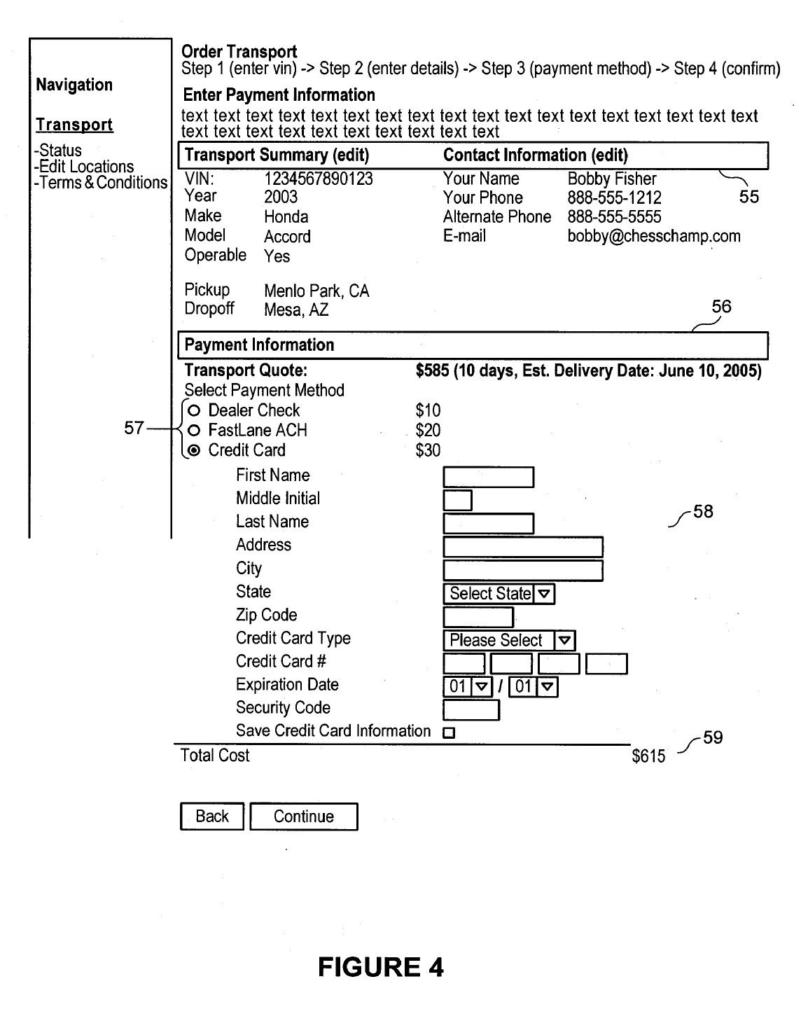

FIG. 6 shows a user interface to confirm to the user an order for transport, according to an embodiment of the invention. The interface to confirm includes a confirmation of sale message 70, purchaser/buyer information 71, payment information 72, vehicle information 73, and more information 74. Confirmation of sale 70 includes a message to the user confirming the transport order. A message may be included indicating that the user should print the page for reference and for the user's accounts payable department. Payment information 72 includes information about the payment selected. This section may include information, for example, on where to send the check. This section may also include an indication that the transport will be suspended or removed if payment is not received within a particular time period of the online purchase date. This may come from a payment days due section in the system. The payment information section would include transport price, processing fee and total amount due, according to an embodiment in the invention. Vehicle information 73 includes a summary of information about the vehicle, such as the year, model, make, VIN, color, interior, mileage, sale date, and transport id. More information section 74 may include additional information, such as a telephone number to contact the seller or a system administrator or a system operator, or other party.

The user may also receive a transport order confirmation e-mail. The e-mail will be sent to the e-mail address stored with the user's contact information. The e-mail may contain the following information or various combinations or subcombinations according to various embodiments of the invention:
Subject: service provider transport order for {VIN #}
Transport ID.
VIN.
Year, make, model, series.
Pick-up location: {pick-up name, city and state}
Drop-off location: {drop-off name, city and state}
Date transport ordered:
Estimated transport date:
Total transport price: {price}
Payment method:
Payment instructions:
{Information listed from the settlement section of the transport configuration}

A note may be included in the next version indicating that user can check on the status of this transport through an online Transport Status Report.

A transport status report includes an online report that allows the dealer to check the status of transport, for example by VIN, or see vehicles for a given month and can provide for scrolling through previous months. The page will list the following:
1. VIN: With link to the transport vehicle status specific page.
2. Year, make, model, series.
3. Date transport ordered.
4. Transport cost.
5. Transport status.

An embodiment includes a transport status page for an individual vehicle. This is the page the user would be directed to if they searched based on the specific VIN or if they clicked on the VIN on the status report. This page may list the following information in various combinations and subcombinations according to various embodiments:
1. VIN.
2. Year, make, model, series.
3. Color.
4. Mileage.
5. Transport Info:
   a. Date purchased.
   b. Transport cost.
   c. Estimated delivery days.
   d. Estimated delivery date.
   e. Estimated drop-off date.
   f. Current status.
   g. Comments to buyer.
6. A back button that takes the user to the previous page they were on.

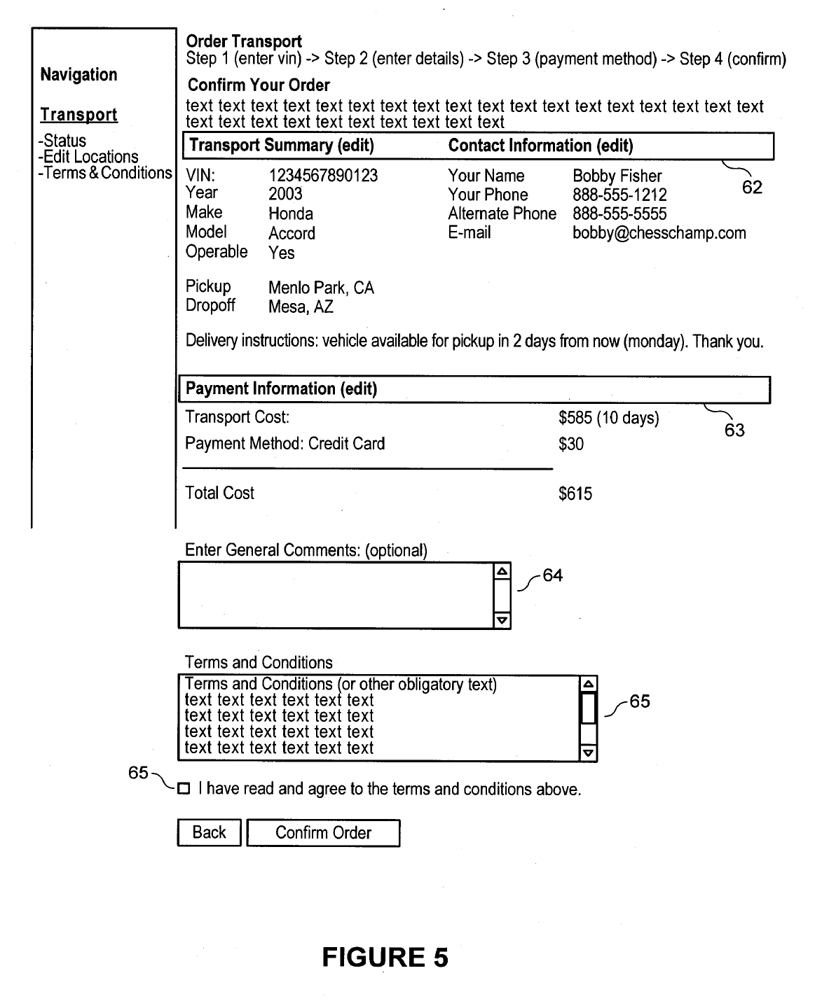

FIG. 100 is a block diagram of a system with a bidding tool, according to an embodiment of the invention. Other tools and network configurations may be used according to other embodiments of the invention. The system shown includes an auction server 101, seller system 102, seller system 120, and buyer system 103. Also shown is network 104. Seller system 102 includes web pages 105, and buyer system 103 includes web pages 106. Auction server 101 includes software 107 and storage 110. Software 107 includes administrative software 108 and auction software 109, and storage includes seller information 111 and buyer information 112. Seller information 111 includes information such as vehicle information 1 13 and 114, and events information 1 15 which includes order 1 16, rules 117 and catalog 118. Auction server 101 is coupled to seller system 102 and buyer system 103 via network 104. Software 107 in auction server 101 operates with storage 110.

Seller system 102 includes functionality to manage inventory (such as vehicles), set up and modify bidding events, and manage bidding events. Such functionality may be included directly in seller system 102 or may be included in auction server 101 or in a combination of software or other logic located in seller system 102 and auction server 101.

Buyer system 103 includes functionality to view catalog items for bidding, to place bids and view an auction, and to select purchase, payment and delivery options for items purchased. This functionality may be included in functionality on buyer system 103, auction server 101 and/or combination of functionality located on auction server 101 and buyer system 103. The functionality may be implemented in software, hardware, or a combination of hardware and software according to various embodiments. Thus, according to various embodiments, the implementations described herein for software may also be implemented in various configurations of software and/or hardware, in distributed or other configurations in various machines and/or networks.

Auction server 101 includes software and storage to manage options and the users of the auctions. Administrative software 108 manages users and information related to users, such as seller information 111 and buyer information 112. Auction software 109 controls an auction including the progress of the auction as requested by seller system 102 and response to bids made by buyer system 103.

Seller system 102 includes web pages 105 that allow seller to enter and display information regarding auction events, inventory, and related administration.

Buyer system 103 includes web pages 106 that allow a buyer to display information regarding bidding as well as enter information commands in order to participate in bidding in auctions.

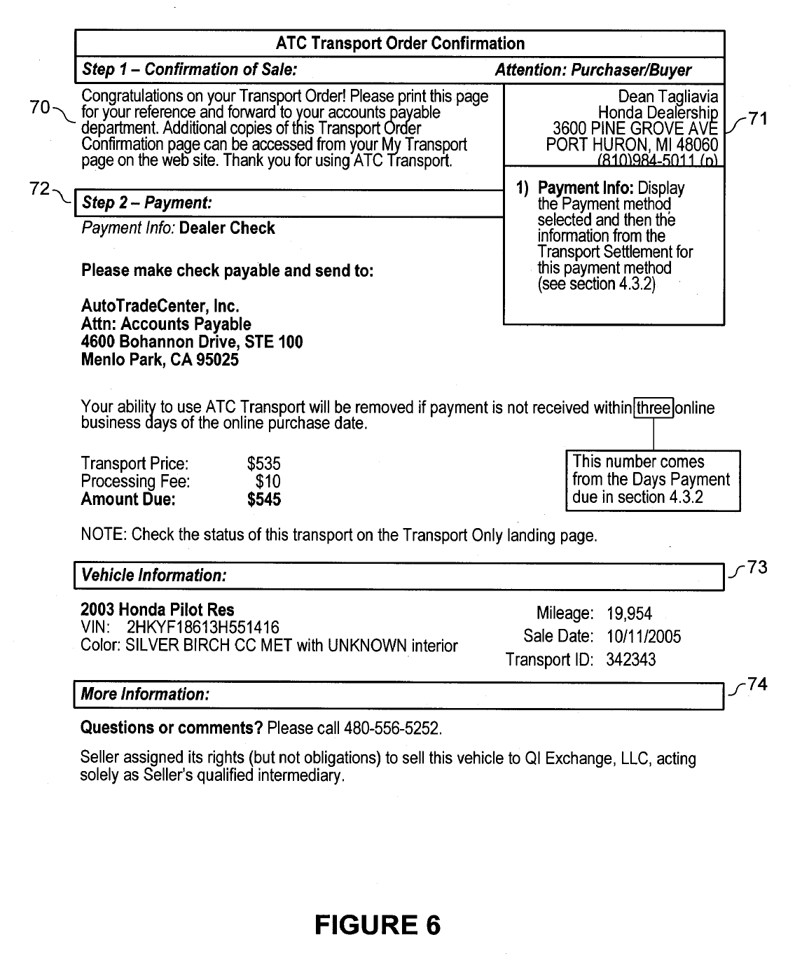

FIG. 200 is a more detailed block diagram of a system with a bidding tool, according to an embodiment of the invention. Other tools and network configurations may be used according to other embodiments of the invention. In the system 200 shown are auction server 201, seller system 202, and buyer system 203. Auction server 201 is coupled to seller system 202 and buyer system 203 through Internet 204. FIG. 200 shows a more detailed view of architecture of the various components of the auction system. Auction sever 201 may include a processor 209 for processing instructions, such as an Intel Pentium™ processor, AMD Athlon™ processor or other processor. Processor 209 is coupled to chip set 208 by a processor bus 211. Chip set 208 is coupled to memory 205 by a memory bus 210 and manages access to memory 205 by processor 209. Chip set 208 is also coupled to peripheral bus 216. Peripheral 216 bus may comprise, for example, PCI, PCI-X, PCI Express, or other peripheral bus. Auction server 201 also includes one or more network interface cards 207 coupled to peripheral bus 216 for providing network interfaces to network, such as Internet 204. Storage 206, such as a disk array or other non-voltage storage, is also coupled to peripheral bus 216.

According to various embodiments, memory 205 and/or storage 206 may include various forms of storage or computer-readable memories such as, but not limited to, volatile memory (random access memory (“RAM”), non-volatile memory (read-only memory (“ROM”)), EEPROM, disk, and/or other storage devices that may include one or more of magnetic, optical storage, or other media. The memory and/or storage on the auction server may be configured as a RAID (Redundant Array of Independent Disks) configuration to provide high reliability access to software and data.

Software may be loaded into memory 205 to help provide auction/bidding function for auction server 201. For example, web server 212 and real-time auction software 213 may be loaded into memory 205 and run by process 209. Web server 212 provides web pages for the users to interact with in order to be provided with auctions/bidding functions. For example, web server 212 may serve up web pages to seller system 202 and buyer system 203 in order to allow seller system 202 to manage inventory events and bidding and to allow buyer system 203 to view events and auction items to make bids and to participate in auctions. Storage 206 includes information about respective users, such as seller information 214 and buyer information 215. This information is used in order to manage the inventory of items for sale, configuration of bidding events, and the processing of real-time bidding. According to various embodiments of the invention, auction system 200 may include one or a plurality of auction servers 201 in various configurations and architectures to provide auctions and bidding functionality.

Seller system 202 and/or buyer system 203 may comprise computer systems coupled to a network such as Internet 204 according to an embodiment. As shown, seller system 202 includes processor 220 and software components such as browser 223 and communications software 221. Also included is a display 224 that allows a user to see information regarding auctions and to perform related administration. Buyer system 203 also includes a processor 230, communication software 231, browser 232, and display 233. Various browser software or other software or functionality to provide user interaction may be used in buyer and seller systems. For example, browsers may include, but are not limited to, Internet Explorer, Netscape browser, Firefox browser, Safari browser or other browser. Alternatively, other user interface software not including a browser may be used.

Software such as web server 212 and real-time auction software 213 may be stored in storage 206 or other storage and may be loaded into memory 205 for manipulation by processor 209 according to an embodiment of the invention. Portions of data such as seller information 214 and buyer information 215 may be loaded into data structures in memory 205 or other storage for manipulation by processor 209 in accordance with software such as web server 212 and real-time auction software 213. Web server 212 includes an operating system for managing system resources, such as Microsoft Windows XP, 2000, 98, or NT, Apple OS, Linux, or other operating systems as well as applications software running on top of the operating systems for implementing an HTML server or other server. Information stored in storage 206 may be stored in various forms of database arrangements and may contain cross references or links to one another to allow information to be queried and retrieved. In an example embodiment, the information is stored in databases, such as relational databases, and may be queried using structured query language (SQL) or other mechanism.

The system may include a secure connection or connections. For example, in an embodiment of the invention, the entire bidding operation of the system operates on a secure connection or connections. Various different technologies may be used to provide a secure connection, such as encryption with, for example, public key and private key encryption. The system may be set up over a virtual private network (VPN).

In an example embodiment, a seller operates seller system 202 through browser 223, communications software 221, and display 224 to set up seller inventory and seller events in seller information storage 214. The seller-user also manages the events and bidding through seller system 202, which communicates via Internet 204 with web server 212.

Buyer system 203 interacts with a buyer user, allowing the buyer user to view items and events including the items for auction. The interaction is provided to the buyer user through display 233, browser 232, and communications software 231, which are controlled by processor 230. Buyer system in turn communicates with auction server 201 via Internet 204. Web server 212 in turn provides buyer system 203 with graphical interface pages which may be displayed on display 233.

An embodiment of the invention is directed to a computerized method in vehicle transport. A request regarding transport of a vehicle is received over a computer network. Electronic information regarding a pick-up location and electronic information regarding a drop-off location for transport of the vehicle are accessed, and base on the electronic information regarding a pick-up location and information regarding a drop-off location for transport of the vehicle quotation of cost for transfer of the vehicle is automatically generated. A quotation for cost for transport of the vehicle is transmitted electronically to the user, over a computer network. A request to transport the vehicle is received from the user, over the computer network, and based on a request to transport the vehicle, an electronic request to a transporter to transport the vehicle is automatically initiated.

The method may include automatically generating the quotation of cost based on zip code of the pick-up location and zip code of the drop-off location. A matrix of difficulty factors based on zip codes of pick-up and drop-off locations may be maintained, and the quotation of cost may be automatically generated based on a respective difficulty factor obtained from the matrix based on a zip code of the pick-up location and zip code of the drop-off location. The difficulty may be based on road mile distances, according to an embodiment of the invention.

A quotation of timing for transport of the vehicle to the user may be transmitted electronically over a computer network, wherein the quotation of timing is applicable to the transport having the quoted costs for a transport of the vehicle. The method may include electronically initiating payment processing using the quotation of cost, wherein the electronically initiating payment processing using quotation of costs includes initiating payment using credit card information provided electronically by the user. The user may be prompted to select between payment methods through and electronic selection over the user interface, wherein the payment methods include credit card and check. Before receiving from the user the request regarding transport of a vehicle, information describing the vehicle may be stored electronically, and after receiving the request regarding transport of the vehicle, the stored information describing the vehicle may be used in effectuating transport of the vehicle.

Information regarding pick-up and drop-off may be electronically stored before receiving from the user the request regarding transport of the vehicle, and the stored information may be used for pick-up and drop-off in effectuating transport of the vehicle after receiving from the user the request regarding transport of the vehicle.

In the electronic user prompt for information regarding a pick-up location and information regarding a drop-off location for transport of the vehicle may be provided, and the prompt may be pre-populated with location information received before receiving from the user the request regarding transport of the vehicle.

Edits to the user contact information in the prompt may be received and processed. A vehicle information number (VIN) of the vehicle may be accessed and based on the VIN of the vehicle, attributes of the vehicle may be determined.

The following may be received from the user: (i) abbreviated information regarding the pick-up and drop-off location for transport of the vehicle and (ii) abbreviated information regarding the vehicle. Upon request from the user, a request for transfer of the vehicle is generated automatically. The abbreviated information regarding the pick-up information and drop-off location may included respective zip codes of pick-up location and drop-off location. The abbreviated information regarding the vehicle may include information as to the size of the vehicle. For example, the information may include an indication of where the vehicle is small, medium or large, and whether the vehicle is operable or inoperable. The abbreviated information may not include the street address of the vehicle or vehicle identification number (VIN) of the vehicle, according to an embodiment of the invention.

An electronic report of status of transport of vehicles may be provided. For example, the report of status may include items such as: vehicle identification number (VIN) of the vehicle, date transport ordered for the vehicle, and status of transport ordered for the vehicle. The electronic report may be transported to the user over the computer network.

Another embodiment of the invention is directed to an automated system in vehicle transport. Such a system may include, in various combinations: an interface to a computer network for data communication; a server for serving up pages, via the interface, to users over the computer network; logic that receives from a user over a computer network a request regarding transport of a vehicle; a data structure storing electronic information regarding a pick-up location and electronic information regarding a drop-off location for transport of the vehicle; logic that, based on the electronic information regarding a pick-up location and information regarding a drop-off location for transport of a vehicle, automatically generates a quotation of cost for transport of the vehicle; logic that initiates electronic transmission to the user, over the computer network using the server, the quotation of cost for transport of the vehicle; logic that receives from, over the computer network, a request to transport the vehicle; and logic that, based on the request to transport the vehicle, automatically initiates an electronic request to transport of the vehicle.

Another embodiment of the invention is directed to an internet-based system. The system may include, in various combinations: logic that serves a web page to a remotely located user including an option to request transport of a vehicle; logic that serves a web page to the remotely located user including a field for entering information regarding a pick-up location and electronic information regarding a drop-off location for transport of the vehicle; logic that, based on the electronic information regarding a pick-up location and information regarding a drop-off location for transport of a vehicle, automatically generates a quotation of cost for transport of the vehicle; logic that serves a web page to the remotely located user including the quotation of cost for transport of the vehicle; logic that serves a web page to the remotely located user including an option to request to transport the vehicle in accordance with the quotation; and logic that, based on user request initiated in a web page served to the user, automatically initiates an electronic request to transport of the vehicle.

An embodiment of the invention is directed to an automated system in vehicles sales.

The system may include, in various combinations: an interface to a computer network for data communication; storage including information regarding: a set of vehicles that undergo sales transactions, and dealers participating in sales transactions; logic that processes on-line sales of the vehicles; logic that prompts a dealer to arrange transport of a vehicle in the set; logic that, based on the electronic information regarding a pick-up location and information regarding a drop-off location for transport of a vehicle, automatically generates a quotation of cost for transport of the vehicle; logic that transmits the quotation to the dealer over the computer network; logic that receives from the dealer, over the computer network, a request to transport the vehicle; and logic that, based on the request to transport the vehicle, automatically initiates an electronic request to transport the vehicle.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory, embedded microprocessors, firmware, software, etc. Furthermore, aspects of the systems and methods may be embodied in microprocessors having software-based circuit emulation, discrete logic (sequential and combinatorial), custom devices, fuzzy (neural network) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the systems and methods may be processed by a processing entity (e.g., one or more processors) within the computer system in conjunction with execution of one or more other computer programs.

Unless the context clearly requires otherwise, throughout the description and the claims, the words ‘comprise,’ ‘comprising,’ and the like are to be construed in an inclusive sense as opposed to an exclusive or exhaustive sense; that is to say, in a sense of ‘including, but not limited to.’ Words using the singular or plural number also include the plural or singular number, respectively. Additionally, the words ‘herein,’ ‘hereunder,’ ‘above,’ ‘below,’ and words of similar import refer to this application as a whole and not to any particular portions of this application. When the word ‘or’ is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

1. A computerized method in vehicle transport comprising:
receiving from a user over a computer network a request regarding transport of a vehicle;
accessing electronic information regarding a pick-up location and electronic information regarding a drop-off location for transport of the vehicle;
based on the electronic information regarding a pick-up location and information regarding a drop-off location for transport of the vehicle, automatically generating a quotation of cost for transport of the vehicle;
electronically transmitting to the user, over the computer network, the quotation of cost for transport of the vehicle;
receiving from the user, over the computer network, a request to transport the vehicle; and
based on the request to transport the vehicle, automatically initiating an electronic request to a transporter to transport the vehicle.

2. The method of claim 1, including automatically generating the quotation of cost based on zip code of the pick-up location and zip code of the drop-off location.

3. The method of claim 1, including maintaining a matrix of difficulty factors based on zip codes of pick-up and drop-off locations, and automatically generating the quotation of cost based on a respective difficulty factor obtained from the matrix based on a zip code of the pick-up location and zip code of the drop-off location.

4. The method of claim 3, including basing difficulty on road mile distances.

5. The method of claim 1, including electronically transmitting to the user, over the computer network, a quotation of timing for transport of the vehicle, wherein the quotation of timing is applicable to the transport having the quoted cost for transport of the vehicle.

6. The method of claim 1, including electronically initiating payment processing using the quotation of cost; and
wherein the electronically initiating payment processing using the quotation of cost includes initiating payment using credit card information provided electronically by the user.

7. The method of claim 1, including prompting the user to select between payment methods through an electronic selection over a user interface, wherein the payment methods include credit card and check.

8. The method of claim 1, including, before receiving from the user the request regarding transport of the vehicle, electronically storing information describing the vehicle, and
after receiving from the user the request regarding transport of the vehicle, using the stored information describing the vehicle in effectuating transport of the vehicle.

9. The method of claim 1, including before receiving from the user the request regarding transport of the vehicle, electronically storing information for pick-up and drop-off, and
after receiving from the user the request regarding transport of the vehicle, using the stored information for pick-up and drop-off in effectuating transport of the vehicle.

10. The method of claim 1, including:
in providing an electronic user prompt for information regarding a pick-up location and information regarding a drop-off location for transport of the vehicle: and pre-populating the prompt with location information received before receiving from the user the request regarding transport of the vehicle.

11. The method of claim 1, including:
providing a user prompt for information regarding a pick-up location and electronic information regarding a drop-off location for transport of the vehicle, pre-populating the prompt with user contact information received before receiving from the user the request regarding transport of the vehicle, and
receiving and processing edits to the user contact information in the prompt.

12. The method of claim 1, including accessing a vehicle information number (VIN) of the vehicle, and based on the VIN of the vehicle, determining attributes of the vehicle.

13. The method of claim 1, including receiving from the user (i) abbreviated information regarding the pick-up location and drop-off location for transport of the vehicle and (ii) abbreviated information regarding the vehicle, and upon request from the user, automatically generating an estimate of cost for transport of the vehicle.

14. The method of claim 13, wherein the abbreviated information regarding the pick-up location and drop-off location for transport of the vehicle includes respective zip codes of pick-up location and drop-off location and wherein the abbreviated information regarding the vehicle includes information as to whether the vehicle is small, medium or large and whether the vehicle is operable or inoperable, and does not include the street address of the vehicle or vehicle identification number (VIN) of the vehicle.

15. The method of claim 1, including:
generating an electronic report of status of transport of a set of vehicles including, for each vehicle:
vehicle identification number (VIN) of the vehicle;
date transport ordered for the vehicle; and
status of transport ordered for the vehicle, and
transmitting the electronic report to the user over the computer network.

16. The method of claim 1, wherein the user comprises a vehicle dealer.

17. An automated system in vehicle transport comprising:
an interface to a computer network for data communication;
a server for serving up pages, via the interface, to users over the computer network;
logic that receives from a user over a computer network a request regarding transport of a vehicle;
a data structure storing electronic information regarding a pick-up location and electronic information regarding a drop-off location for transport of the vehicle;
logic that, based on the electronic information regarding a pick-up location and information regarding a drop-off location for transport of a vehicle, automatically generates a quotation of cost for transport of the vehicle;
logic that initiates electronic transmission to the user, over the computer network using the server, the quotation of cost for transport of the vehicle;
logic that receives from, over the computer network, a request to transport the vehicle; and
logic that, based on the request to transport the vehicle, automatically initiates an electronic request to transport of the vehicle.

18. The system of claim 17, including:
a matrix of difficulty factors based on zip codes of pick-up and drop-off locations, and
logic that automatically generates the quotation of cost based on a respective difficulty factor obtained from the matrix based on a zip code of the pick-up location and a zip code of the drop-off location.

19. The system of claim 17, including logic that generates a quotation of timing for transport of the vehicle corresponding to transport for which the quoted cost for transport of the vehicle was provided.

20. The system of claim 17, including logic that electronically initiates payment processing using the quotation of cost.

21. The system of claim 17, including:
storage for information describing a set of vehicles, the information provided before receiving from a user the request regarding transport of a vehicle, and
logic that uses information regarding the respective vehicle in the stored information in effectuating transport of the vehicle.

22. The system of claim 17, including:
storage for information regarding location of a set of vehicles, the information provided before receiving from a user the request regarding transport of a vehicle, and
logic that uses information regarding location of the respective vehicle in the stored information regarding location in effectuating transport of the vehicle.

23. The system of claim 17, including logic that receives from a user (i) abbreviated information regarding the pick-up location and drop-off location for transport of the vehicle, and (ii) abbreviated information regarding the vehicle, and upon request from the user, automatically generates an estimate of cost for transport of the vehicle.

24. The system of claim 17, including:
storage of information for a set of vehicles involved in transport including, for each vehicle,
vehicle identification number (VIN) of the vehicle;
date transport ordered for the vehicle; and
status of transport ordered for the vehicle; and
logic that generates electronic reports based on the information to respective users associated with respective vehicles.

25. A Internet-based system comprising:
logic that serves a web page to a remotely located user including an option to request transport of a vehicle;
logic that serves a web page to the remotely located user including a field for entering information regarding a pick-up location and electronic information regarding a drop-off location for transport of the vehicle;
logic that, based on the electronic information regarding a pick-up location and information regarding a drop-off location for transport of a vehicle, automatically generates a quotation of cost for transport of the vehicle;
logic that serves a web page to the remotely located user including the quotation of cost for transport of the vehicle;
logic that serves a web page to the remotely located user including an option to request to transport the vehicle in accordance with the quotation; and
logic that, based on user request initiated in a web page served to the user, automatically initiates an electronic request to transport of the vehicle.

26. The system of claim 25 including logic that serves a web page including fields for zip code of the pick-up location and zip code of the drop-off location.

27. The system of claim 25 including logic that serves a web page including an option for the user to select payment method, wherein the payment method includes a credit card.

28. The system of claim 25 including logic that serves a web page pre-populated with information describing the vehicle, the information received before receiving from a user a request regarding transport of the vehicle.

29. The system of claim 25 including logic that serves a web page pre-populated with information for pick-up and drop-off location of the vehicle, the information for pick-up and drop-off location of the vehicle received before receiving from a user a request regarding transport of the vehicle.

30. The system of claim 25 including logic that serves a web page including (i) a first prompt for the user to initiate a quotation of cost for transport of a specific vehicle based on detailed information, and (ii) a second prompt for the user to initiate an estimate of cost for transport based on less detailed information.

31. The system of claim 25, wherein the detailed information includes the vehicle identification number (VIN) and the less detailed information includes respective zip codes of pick-up location and drop-off location and does not include street address of the vehicle.

32. An automated system in vehicle sales comprising:
an interface to a computer network for data communication;
storage including information regarding:
a set of vehicles that undergo sales transactions, and
dealers participating in sales transactions;
logic that processes on-line sales of the vehicles;
logic that prompts a dealer to arrange transport of a vehicle in the set;
logic that, based on the electronic information regarding a pick-up location and information regarding a drop-off location for transport of a vehicle, automatically generates a quotation of cost for transport of the vehicle;
logic that transmits the quotation to the dealer over the computer network;
logic that receives from the dealer, over the computer network, a request to transport the vehicle; and
logic that, based on the request to transport the vehicle, automatically initiates an electronic request to transport the vehicle.

33. The automated system of claim 32, including logic that presents vehicles from among the set of vehicles for bidding in an auction, receives bids on the vehicles, and processes sales of the vehicles based on the bidding.

34. The automated system of claim 32, including logic that presents vehicles from among the set of vehicles for sale in a non-auction based transaction, receives offers on the vehicles, and processes sales of the vehicles based on the offers.

35. The automated system of claim 32, including logic that uses information received regarding the vehicle in connection with sales transactions in advance of a user request for sale of the vehicle to estimate cost of transport of the vehicle and provided the quotation for cost for transport of the vehicle.

36. A computerized method in vehicle transport comprising:
means for receiving from a user over a computer network a request regarding transport of a vehicle;
means for accessing electronic information regarding a pick-up location and electronic information regarding a drop-off location for transport of the vehicle;
means for, based on the electronic information regarding a pick-up location and information regarding a drop-off location for transport of a vehicle, automatically generating a quotation of cost for transport of the vehicle;
means for electronically transmitting to the user, over the computer network, the quotation of cost for transport of the vehicle;
means for receiving from the user, over the computer network, a request to transport the vehicle; and
means for, based on the request to transport the vehicle, automatically initiating an electronic request to transport the vehicle.
